(19) United States
(12) Patent Application Publication
(10) Pub. No.: US 2025/0021637 A1
(43) Pub. Date: Jan. 16, 2025

(54) FIELD DEVICE, FIELD DEVICE NETWORK AND METHOD FOR USER ACCESS

(71) Applicant: VEGA Grieshaber KG, Wolfach (DE)

(72) Inventors: Volker ALLGAIER, Haslach i. K. (DE); Clemens HENGSTLER, Haslach (DE); Marcel DIETERLE, Schiltach (DE)

(73) Assignee: VEGA Grieshaber KG, Wolfach (DE)

(21) Appl. No.: 18/714,651

(22) PCT Filed: Nov. 29, 2022
(86) PCT No.: PCT/EP2022/083667

§ 371 Date: May 30, 2024

(30) Foreign Application Priority Data
Nov. 30, 2021 (DE) 10 2021 131 410.0

(51) Int. Cl. G06F 21/44

(52) U.S. Cl. CPC G06F 21/44

(57) ABSTRACT

A field device for industrial automation having a user interface which communicates with a user, computer network interface circuitry which connects the field device to a computer network service, and control circuitry. The control circuitry receives user data for local user access via the user interface, to send the user data to the computer network service, to receive first authorization data from the computer network service via the computer network interface, and to grant access to the field device as a function of the first authorization data.

### REFERENCE TO RELATED APPLICATIONS

The present application claims priority from German patent application No. 10 2021 131 410.0, filed on Nov. 30, 2021, which is incorporated herein by reference in its entirety.

### TECHNICAL FIELD

The invention relates to a field device, e.g. a sensor, of industrial automation, a field device network, a use of a computer network device for granting access to a field device and a method for granting access to a field device in a field device network.

### BACKGROUND

To gain access to an industrial sensor in a sensor network for service purposes, for example, a user on site only needs access data. However, security requirements are increasing and additional methods for checking and granting access authorization are required. One known method is authentication, for example.

### SUMMARY

One objective could be to provide a field device with improved user access.

The problem is solved by the subject-matter of the independent patent claims. Advantageous embodiments are the subject of the dependent claims, the following description and the figures.

The described embodiments similarly relate to the industrial automation field device, the field device network, the use of a computer network device to grant access to a field device, and the method of granting access to a field device in a field device network. Synergistic effects may result from various combinations of the embodiments, although they may not be described in detail.

Furthermore, it should be noted that all embodiments of the present invention relating to a method may be carried out in the described order of steps, but this need not be the sole and essential order of steps of the method. The methods presented herein may be carried out with a different sequence of the disclosed steps without deviating from the particular method embodiment, unless expressly stated otherwise below.

Technical terms are used with the meaning known to the person skilled in the art. If certain terms are given a specific meaning, definitions of terms are given below, in the context of which the terms are used.

According to a first aspect, an industrial automation field device is proposed, wherein the field device comprises a user interface configured to communicate with a user, a computer network interface configured to connect the field device to a computer network service, and a control device. The control device is configured to receive user data for local user access via the user interface, to send the user data to the computer network service, to receive first authorization data from the computer network service via the computer network interface, and to grant access to the field device depending on the first authorization data.

The field device is, for example, an automation or automation sensor, such as factory or process automation in an industrial environment. Process automation in an industrial environment can be understood as a branch of technology that includes all measures for the operation of machines and systems without human involvement. One aim of process automation is to automate the interaction of individual components of a plant in the chemical, food, pharmaceutical, petroleum, paper, cement, shipping or mining sectors. A variety of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as fill level, limit level, flow rate, pressure or density can be monitored and settings for the entire plant can be changed manually or automatically.

One area of process automation in the industrial environment is logistics automation. Distance and angle sensors are used in logistics automation to automate processes within a building or within an individual logistics system. Typical applications for logistics automation systems include baggage and freight handling at airports, traffic monitoring (toll systems), retail, parcel distribution and building security (access control). What the examples listed above have in common is that presence detection in combination with precise measurement of the size and position of an object is required by the respective application. Sensors based on optical measurement methods using lasers, LEDs, 2D cameras or 3D cameras, which detect distances according to the time-of-flight (ToF) principle, can be used for this purpose.

Another area of process automation in the industrial environment is factory/production automation. Applications for this can be found in a wide variety of sectors such as automotive manufacturing, food production, the pharmaceutical industry or in the packaging sector in general. The aim of factory automation is to automate the production of goods using machines, production lines and/or robots, i.e. to run them without human intervention. The sensors used here and the specific requirements in terms of measuring accuracy when detecting the position and size of an object are comparable to those in the previous example of logistics automation.

User data here means data from a user, i.e. not necessarily or not only data about a user. In the simplest case, the user data contains a single bit or a switching signal. However, it can also contain digits, a name and/or a password. Receipt of the user data also represents an access request.

The computer network can, for example, be a so-called cloud, whereby a cloud can be regarded as a model that usually—but not necessarily-provides shared computer resources as a service, for example in the form of servers, data storage or applications, via the Internet and independently of the device, promptly and with little effort. The computer network or cloud can be a public, private, hybrid public-private or virtual private computer network, or any hybrid of these. The control of resources is centralized. The term “cloud” is used here as a representative term for such a computer network, without thereby restricting the term “computer network”.

The computer network interface or cloud interface is an interface, e.g. an Internet interface, to the computer network or a cloud, i.e. a network with a large number of network nodes and services.

The user interface can be an MMI interface and/or, for example, a wireless interface to a user device, such as a mobile device, a laptop, a proprietary device, etc.

User access is the authorization to operate the field device functionally and/or, in particular, to make changes to the device, such as configuring or parameterizing the field device or reading stored data that is not regularly output during operation or physical access. For example, the user, in this case the second user, requires access for maintenance purposes.

The authorization data is data that is transmitted, for example, according to an authentication method and is necessary to grant the user access to the field device. The field device or the control device of the field device can receive authorization data from the computer network service and/or from the user, which can be different. First authorization data is authorization data from the computer network service via the computer network interface to the field device and second authorization data is authorization data from the second user via the user interface to the field device.

“Local” means that the user is in the immediate vicinity of the field device and can operate it through physical contact, e.g. by pressing a button or touching a display.

Access to a field device on site is often required for maintenance or service purposes, for example. The field device now has electronic access protection that requires authentication. Authentication is achieved by connecting the field device to a computer network service. Such a computer network service can either operate completely automatically, or it can be monitored or supported by a first user. In the latter case, the first user can, for example, release the authorization data or block access immediately if an irregularity is detected.

The user on site, referred to here as the “second user”, uses a user interface, e.g. a human-machine interface (HMI) of the field device, to request access to the field device. The field device then sends a message with the user data to the cloud computer network, i.e. to a responsible computer network service, which responds with initial authorization data.

The “granting” of access involves two “stages”. The first stage concerns the decision to grant access in the computer network and the second stage concerns the physical access to the field device that follows the decision. The respective stage is clear from the context.

The control device sends and receives data. Expressions such as “Data is sent to the field device” or “Data is received by the field device” mean that the control device of the field device receives or sends the data.

According to one embodiment, the first authorization data contains a password or a sequence of digits, e.g. a PIN or a random digit sequence.

The first authorization data that the field device receives from the computer network can consist of authorization data stored in the computer network and/or generated by the computer network service. However, the first authorization data can also be data generated by a first user who operates the computer network service. For example, the authorization data can be a user-specific password, a stored sequence of digits, e.g. a PIN, or a random sequence of digits.

According to one embodiment, the user interface is also configured to receive second authorization data, and the control device is configured to compare the first authorization data with the second authorization data and to grant access if they match.

The computer network service thus sends the first authorization data to the field device and/or to a device of the second user, such as a smartphone. In the event that the computer network service sends the authorization data to the field device, authentication can be carried out in various ways. For example, the first authorization data and the second authorization data entered by the second user contain a user password that the control device compares. The second authorization data is therefore also a password or a random number sequence, for example, which the field device receives from the second user or a user device used by this user, such as a mobile device, a tablet, a laptop or a proprietary device, so that the control device of the field device can carry out the comparison with the first authorization data. This user device of the second user is referred to herein as the “second user device”.

According to one embodiment, the control device is also configured to output at least part of the first authorization data.

For example, the field device has a display and the initial authorization data, e.g. the PIN or the random digits, are shown on the display. The first authorization data is therefore e.g. displayable data, such as displayable codes. This also includes QR codes, for example, that may be read using a QR code reader. The user can therefore only access the field device if they are on site to read the display and enter the PIN, e.g. via the human-machine interface, e.g. a keypad or a touch-sensitive display. Alternatively, the control device can send the first authorization data to the user device of the second user via a wireless connection as a user interface, e.g. via a wireless short-distance connection. The user device displays the data, and the user can enter the displayed data on the field device. In a further alternative, the user enters the data displayed on the field device on the user device, which sends this data to the field device via a wireless connection.

In an alternative embodiment, the second user can send the second authorization data to the field device via the user interface or the human-machine interface, for example personal access data (“credentials”), i.e. name and password, and the control device of the field device forwards the second authorization data to the computer network service, which compares the second authorization data with the e.g. stored first authorization data, and sends a release to the field device, so that the field device is released for access.

According to one embodiment, the control device is also configured to send a log of activities on the field device to the computer network service after access has been granted.

The control device of the field device can record the actions of the second user. For example, it can store a log file containing the connection data, including the times of the start and end of the connection, as well as parameters and configurations that have been changed, for example. The stored data can be sent to the computer network, e.g. to the cloud service or to the first user, at a suitable time.

According to one embodiment, the control device is also configured to send activities on the field device to the computer network service in real time via the computer network interface.

In the case of data recording, no active connection to the computer network is required as long as it is running. However, this is a prerequisite for real-time data transmission. The advantage of real-time data transmission is that the first user can monitor the activities and possibly block access.

According to one embodiment, the control device is also configured to grant access to the second user device via an encryption method after receiving the first authorization data.

The request, i.e. the user data, can, for example, contain data that is converted into a telephone number or other data in order to communicate with the second user device. For example, an application can run on the second user device that communicates with the field device. According to this embodiment example, the user does not need to enter a PIN to ultimately gain access. The second user device is verified via the telephone number and the communication to grant access may be a communication using an encryption method based on e.g. public and private keys.

With respect to the control of access by a first user, the first user may operate a device, such as a terminal, that is connected to the computer network and to the computer network service. In one example, the terminal or the computer connected to the terminal may have a program, e.g. an application. The application can have an input screen via which the first user can control and configure the access of the second user. For example, the first user can enter the duration of access or a start and end time, or he can select a set of parameters that the second user can access, etc.

The user device of the second user can also have an application. This application can, for example, display a button before the connection request with which the second user can request the “remote release”. When this button is pressed, the request is forwarded to the computer network and, if necessary, to the first user, where it is processed automatically or by the first user.

According to one embodiment, the computer network interface is configured to establish a tunnel to the computer network service via the user interface.

It is therefore possible to tunnel the connection from the field device to the computer network service via the user interface and the second user device to the computer network service, so that the computer network interface can be a tunneled interface, but the processing and response can also be transmitted via another form of transmission, such as an SMS.

According to a further aspect, a computer network device comprising a processor adapted to process a computer network service is proposed, wherein the computer network service is adapted to receive user data from a field device as an access request to the field device and to send first authorization data to the field device in response to the user data.

The computer network, e.g. a cloud device, is a piece of hardware, e.g. a computer of a network node of the cloud with a processor. Software that provides the computer network service described herein is executed on the processor of the cloud device. In embodiments according to e.g. a configuration or a programming, the computer network device can independently make decisions about granting the second user access to the field device and/or receive the decision from the first user via an interface to the first user. This interface can thus be a man-machine interface, in which, for example, a monitor and a keyboard are connected to the computer network device, or a wireless or wired interface to another computer in or outside the computer network.

According to a further aspect, there is proposed a field device network comprising a field device as described herein and a field device computer network device as described herein.

According to an embodiment, the field device network thus also has a first user device which is configured to receive control commands from a first user, for example via a human-machine interface, and to generate the first authorization data as a function of the control commands and send it to the computer network service. The computer network service then forwards the first authorization data to the field device.

According to one embodiment, the field device network further comprises a second user device, such as the second user device described above and in the figures, which is configured to provide user data of a second user and to send an access request to the field device.

According to a further aspect, a method for granting access to a field device in a field device network is proposed, comprising the following steps, which are carried out by a control device of the field device: Receiving user data as an access request via a user interface of the field device, sending the user data to a computer network service, receiving first authorization data from the computer network service, and granting access to the field device depending on the first authorization data.

The method may further comprise several or all of the actions and functionalities described with respect to the field device and the field device network in the present disclosure.

According to a further aspect, a use of such a computer network device for granting a user access to a field device is proposed.

According to a further aspect, there is provided a computer program element which, when executed on a processor of a field device described herein, instructs the field device to perform the method described herein.

The computer program element may be part of a computer program, but it may also be an entire program in itself. For example, the computer program element may be used to update an existing computer program to arrive at the present invention.

### BRIEF DESCRIPTION OF THE FIGURES

In the following, embodiments of the invention are explained in more detail with reference to the schematic drawings.

FIG. 1 shows a block diagram of a field device network with a field device according to a first example;

FIG. 2 shows a block diagram of a field device network with a field device according to a second example;

FIG. 3 shows a flowchart of the procedure for granting access to a field device in a field device network.

Corresponding parts are marked with the same reference signs in all figures.

### DESCRIPTION OF EMBODIMENTS

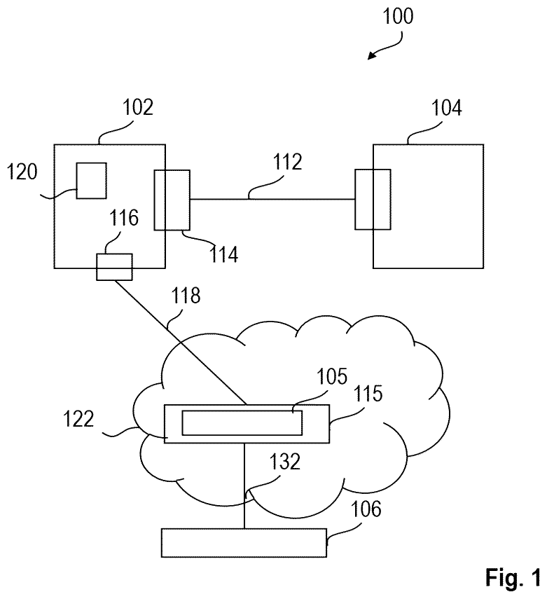

FIG. 1 shows a block diagram of a field device network 100 with a field device 102, a second user or user device 104 and a network service in a network with a central computer, e.g. cloud service 105 in the cloud 122, and a first user 106 or terminal 106, which is connected to the cloud service 105 in the cloud 122. The field device 102 has a control device 120 as well as a user interface 114 and a cloud interface 116. The user interface is shown in FIG. 1 as a connection 112 between the field device 102 and the second user device 104 and the field device-side part of the user interface 114. The cloud interface 116, 118 is shown as a connection 118 between the field device 102 and the cloud service 105 as well as the field device-side part 116 of the cloud interface. A first user device 106 is connected to the cloud device 115, which includes the cloud service 105, via the connection 132.

In the following, three example scenarios are shown as to how a user 104 on site, i.e. the “second user”, can gain access to the field device 102. In general, the second user can make his inputs directly via a human-machine interface on the field device 102 itself or, as shown in FIG. 1, with a user device 104 via, for example, a Bluetooth connection or other short-range wireless connection, depending on the equipment of the field device 102 and the user device 104. For the sake of clarity, inputs are described in the following examples as inputs from the second user, regardless of whether he makes them directly on the field device 102 or on the user device 104. The user device 104 can also be considered in one of its functions as an extended input interface of the field device 102.

In a first, very simple example scenario, the second user presses a button, for example on the field device 102 or a touch-sensitive display or its user device 104. The control device 120 of the field device 102, which is connected to the cloud 100, forwards the request as user data to a cloud service 105. The cloud service 105 responds with a temporary random number or a PIN as the first authorization data, which is displayed on the field device 102. The second user enters the PIN and types it in for confirmation. This ensures that the user is on site. Numerous variants are possible here. For example, the cloud service 105 can send a QR code, which the second user device 104 scans and sends back a confirmation without the user having to make an entry. In another case, the field device 102 sends the first authorization data to the user device 104, which responds automatically. Since the connection 112 is a short-range connection, this is sufficient to determine that the second user is on site. The cloud service 105 can be assigned various tasks here: it can determine current rules, e.g. whether and for how long access is enabled, it can register that the second user has logged in and can make recordings and, for example, create a log file. Furthermore, it would be possible to monitor user activities on the field device 102 in real time and to block access if unauthorized actions take place on the field device 102. The cloud service 105 may also have an interface 132 to a first user 106 that controls said cloud service activities.

In a second example scenario, the user enters his ID. The control device 120 of the field device 102 forwards the ID as the first user data to the cloud service 105, which checks the ID. A code, e.g. a PIN, could now be stored for the ID, which the cloud service 105 sends to the field device 102 as initial authorization data. The field device 102 now requests the PIN from the second user and grants access if it matches. Here too, the cloud service 105 takes over the release, on the condition that the PIN still has to be entered by the user and the match is successfully checked in the field device. Users not registered in the cloud 122 are not granted access from the outset. Alternatively, the cloud service can send a temporary PIN to the field device, as in the first example.

In a third example scenario, the second user enters his ID and a password as the first user data. In this case, the cloud service 105, which is also subject to user management, for example, can send the release to the field device 102 without any further user action being necessary. Alternatively, the methods mentioned in the first and second examples can also be used.

The cloud service 105 can also (not shown in FIG. 1) send first authorization data directly to the user device for 2-factor authentication instead of only to the field device. For example, the user device is a cell phone, and the cloud service 105 sends an SMS with second authorization data, e.g. a temporary PIN, to the cell phone, which the second user must enter at the field device 102. The field device 102 can now compare the first authorization data received from the cloud service with the second authorization data entered and grant access if they match.

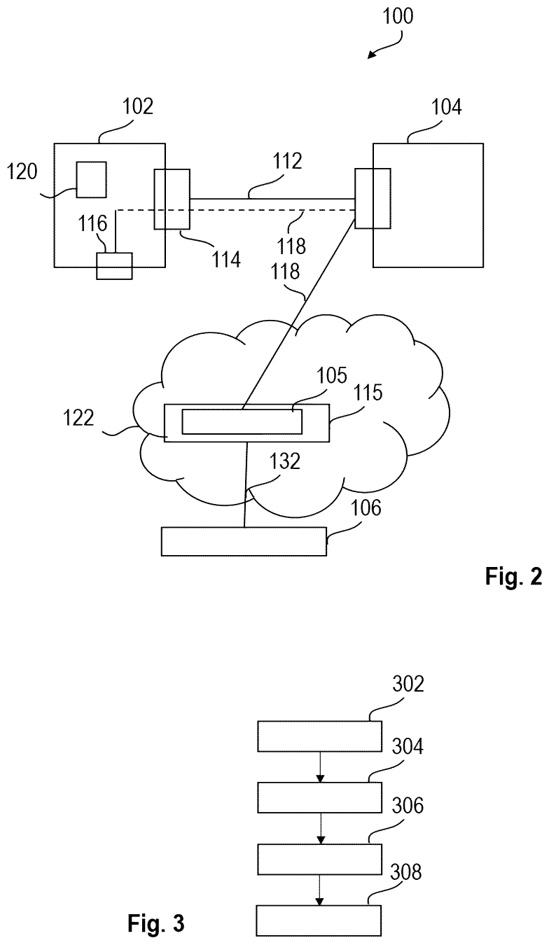

FIG. 2 shows a block diagram of a field device network 100 with a field device 102, a second user or second user device 104 as well as a cloud service 105 and a first user 106 or first user device 106, e.g. a terminal or computer, which is connected to the cloud service 105. The connection of the field device 102 to the cloud service 105 is tunneled here via the user device 104. This means that the cloud connection 118, e.g. an Internet connection such as an IoT connection, uses the protocol of the short-range connection between the field device 102 and the second user device 104. All the example scenarios described with reference to FIG. 1 can also be applied using this tunnel.

FIG. 3 shows a flowchart of the method for granting access to a field device 102 in a field device network 100, comprising the following steps, which are performed by a control device 120 of the field device 102:

The first step includes receiving 302 user data as an access request via a user interface 114 of the field device 102. The second step includes sending 304 the user data to a cloud service 105, the third step of receiving 306 first authorization data from the cloud service 105, and the fourth step of granting 308 access to the field device 102 depending on the first authorization data.

Other variations of the disclosed embodiments may be understood and carried out by one skilled in the art in practicing the claimed invention by studying the drawings, the disclosure and the appended claims. In the claims, the word “comprising” does not exclude other elements or steps, and the indefinite article “one” or “a” does not exclude a plurality. A single processor or other unit may perform the functions of multiple items or steps recited in the claims. The mere fact that certain measures are specified in interdependent claims does not mean that a combination of these measures cannot be used advantageously. Reference signs in the claims should not be construed to limit the scope of the claims.

1. An industrial automation field device, comprising:
a user interface configured to communicate with a user; and
computer network interface circuitry configured to interface to a computer network with a central computer, which is configured to connect the industrial automation field device to a computer network service; and
control circuitry configured to
receive user data for local user access via the user interface,
send the user data to the computer network service,
receive first authorization data from the computer network service via the computer network interface circuitry, and
grant access to the field device depending on the first authorization data.

2. The field device according to claim 1, wherein the first authorization data includes a password or a sequence of digits.

3. The field device according to claim 1, wherein the user interface is further configured to receive second authorization data, and the control circuitry is further configured to compare the first authorization data with the second authorization data and to grant access if they match.

4. The field device according to claim 1, wherein the control circuitry is further configured to output the first authorization data via the user interface.

5. The field device according to claim 1, wherein the control circuitry is further configured to grant access to a second user device using an encryption method after receiving the first authorization data.

6. The field device according to claim 1, wherein the control circuitry is further configured to send a log of activities on the field device to the computer network service after access has been granted.

7. The field device according to claim 1, wherein the control circuitry is further configured to send activities on the field device to the computer network service in real time via the computer network interface circuitry.

8. The field device according to claim 1, wherein the computer network interface circuitry is further configured to establish a tunnel via the user interface to the computer network service.

9. A computer network device comprising:
a processor adapted to process a computer network service, wherein the computer network service is configured to receive user data from the field device according to claim 1 as an access request to the field device and to send first authorization data to the field device in response to the user data.

10. A field device network, comprising
the field device according to claim 1; and
a computer network device including a processor adapted to process a computer network service, wherein the computer network service is configured to receive user data from the field device as an access request to the field device and to send first authorization data to the field device in response to the user data.

11. The field device network according to claim 10, further comprising a first user device configured to receive control commands from a first user, and configured to generate and send the first authorization data to the computer network service in dependence on the control commands.

12. The field device network according to claim 10, further comprising a second user device configured to provide user data of a second user and to send an access request to the field device.

13. A method of granting access to a field device in a field device network, comprising, by a control device of the field device:
receiving user data as an access request via a user interface of the field device;
sending the user data to a computer network service;
receiving first authorization data from the computer network service; and
granting access to the field device depending on the first authorization data.

14. (canceled)

15. A non-transitory computer readable medium having stored thereon a computer program element which, when executed on a processor of a field device having a user interface configured to communicate with a user, and computer network interface circuitry configured to interface to a computer network with a central computer, which is configured to connect the field device to a computer network service, and control circuitry configured to receive user data for local user access via the user interface, send the user data to the computer network service, receive first authorization data from the computer network service via the computer network interface circuitry, and grant access to the field device depending on the first authorization data, instructs the field device to perform the method according to claim 13.

16. The field device according to claim 2, wherein the user interface is further configured to receive second authorization data, and the control circuitry is further configured to compare the first authorization data with the second authorization data and to grant access if they match.

17. The field device according to claim 2, wherein the control circuitry is further configured to output the first authorization data via the user interface.

18. The field device according to claim 3, wherein the control circuitry is further configured to output the first authorization data via the user interface.

19. The field device according to claim 2, wherein the control circuitry is further configured to grant access to a second user device using an encryption method after receiving the first authorization data.

20. The field device according to claim 3, wherein the control circuitry is further configured to grant access to a second user device using an encryption method after receiving the first authorization data.

21. The field device according to claim 4, wherein the control circuitry is further configured to grant access to a second user device using an encryption method after receiving the first authorization data.
